(19) United States
(12) Patent Application Publication
(10) Pub. No.: US 2026/0326609 A1
(43) Pub. Date: Oct. 22, 2026

(54) VEHICLE SERVICE MANAGEMENT DEVICE, VEHICLE SERVICE MANAGEMENT METHOD, AND VEHICLE SERVICE MANAGEMENT PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Kazuki KITAGAWA, Yokkaichi-shi, Mie (JP); Yuji TSUJI, Yokkaichi-shi, Mie (JP); Kentaro ASHIBE, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/491,165

(22) PCT Filed: May 27, 2024
(86) PCT No.: PCT/JP2024/019431

§ 371 Date: Dec. 8, 2025

(30) Foreign Application Priority Data
Jun. 12, 2023 (JP) 2023-096092

(51) Int. Cl. B60L 58/12; B60R 16/033

(52) U.S. Cl. CPC B60L 58/12; B60R 16/033

(57) ABSTRACT

A vehicle service management device installed in a vehicle and including: a monitoring unit configured to monitor a battery charge of a battery included in the vehicle in a target state in which the vehicle is stopped or parked; a suspension charge obtaining unit configured to obtain a suspension charge that is an amount of charge of the battery necessary to suspend a target service that is a service executed in the vehicle in the target state; and a determination unit configured to perform suspension determination processing for determining suspension of the target service that is being executed, based on the battery charge monitored by the monitoring unit and the suspension charge obtained by the suspension charge obtaining unit.

### CROSS-REFERENCE TO RELATED APPLICATIONS

This application is the U.S. national stage of PCT/JP2024/019431 filed on May 27, 2024, which claims priority of Japanese Patent Application No. JP 2023-096092 filed on Jun. 12, 2023, the contents of which are incorporated herein.

### TECHNICAL FIELD

The present disclosure relates to a vehicle service management device, a vehicle service management method, and a vehicle service management program.

### BACKGROUND

JP 2019-055667A discloses an in-vehicle electronic control device described below. That is, in the in-vehicle electronic control device, a control voltage is supplied via a suspension constant voltage circuit to an arithmetic control unit to which the control voltage is supplied from an in-vehicle battery via a main power supply switching element, a pre-stage constant voltage circuit, and a post-stage constant voltage circuit using, as a power source, a suspension power supply voltage obtained via a power failure auxiliary capacitor charged from the in-vehicle battery via a first reverse current blocking diode or a second reverse current blocking diode and a suspension power supply switching element, and even if a ground fault abnormality occurs in a power supply line, a reverse current is blocked by an output transistor in the post-stage constant voltage circuit, and reverse discharge of the power failure auxiliary capacitor is prevented.

For example, there are cases where a surroundings monitoring service or the like is provided while a vehicle is stopped or parked. In such a case, an in-vehicle device that corresponds to the service operates with power supplied from a battery of the vehicle, for example.

If the power supply from the battery stops when the service is being executed while the vehicle is stopped or parked, there is a possibility of the executed service failing to end normally and a problem such as hang-up or breakdown occurring in the in-vehicle device corresponding to the service. There is demand for a technology that can suspend the executed service at an appropriate timing.

The present disclosure was made to solve the above problem, and an object of the present disclosure is to provide a vehicle service management device, a vehicle service management method, and a vehicle service management program that can suspend a service that is being executed in a stopped or parked vehicle at an appropriate timing.

### SUMMARY

A vehicle service management device according to the present disclosure is a vehicle service management device installed in a vehicle, including: a monitoring unit configured to monitor a battery charge of a battery included in the vehicle in a target state in which the vehicle is stopped or parked; a suspension charge obtaining unit configured to obtain a suspension charge that is an amount of charge of the battery necessary to suspend a target service that is a service executed in the vehicle in the target state; and a determination unit configured to perform suspension determination processing for determining suspension of the target service that is being executed, based on the battery charge monitored by the monitoring unit and the suspension charge obtained by the suspension charge obtaining unit.

An aspect of the present disclosure can be realized not only as a vehicle service management device including such characteristic processing units, but also as a semiconductor integrated circuit that realizes part or the entirety of the vehicle service management device, or a system including the vehicle service management device.

### Advantageous Effects

According to the present disclosure, it is possible to suspend a service that is being executed in a stopped or parked vehicle at an appropriate timing.

### BRIEF DESCRIPTION OF DRAWINGS

FIG. 1 is a diagram showing an example of a configuration of an in-vehicle system according to an embodiment of the present disclosure.

FIG. 2 is a diagram showing an example of a configuration of a vehicle service management device according to an embodiment of the present disclosure.

FIG. 3 is a diagram showing an example of a correspondence table stored in the vehicle service management device according to an embodiment of the present disclosure.

FIG. 4 is a diagram showing an example of a statistical table stored in the vehicle service management device according to an embodiment of the present disclosure.

FIG. 5 is a diagram showing an example of the statistical table updated by the vehicle service management device according to an embodiment of the present disclosure.

FIG. 6 is a diagram showing an example of the correspondence table updated by the vehicle service management device according to an embodiment of the present disclosure.

FIG. 7 is a flowchart showing an operation procedure of suspension determination processing performed by the vehicle service management device according to an embodiment of the present disclosure.

FIG. 8 is a flowchart showing the operation procedure of the suspension determination processing performed by the vehicle service management device according to an embodiment of the present disclosure.

FIG. 9 is a diagram showing an example of a sequence of processing performed by the vehicle service management device and in-vehicle devices included in the in-vehicle system according to an embodiment of the present disclosure.

FIG. 10 is a diagram showing an example of a configuration of an in-vehicle system according to Variation 1 of an embodiment of the present disclosure.

FIG. 11 is a diagram showing an example of a configuration of a vehicle service management device according to Variation 1 of an embodiment of the present disclosure.

FIG. 12 is a diagram showing an example of a correspondence table updated by the vehicle service management device according to Variation 1 of an embodiment of the present disclosure.

FIG. 13 is a diagram showing an example of a statistical table updated by the vehicle service management device according to Variation 1 of an embodiment of the present disclosure.

FIG. 14 is a diagram showing another example of the statistical table updated by the vehicle service management device according to Variation 1 of an embodiment of the present disclosure.

FIG. 15 is a diagram showing an example of a correspondence table stored in a vehicle service management device according to Variation 2 of an embodiment of the present disclosure.

### DESCRIPTION OF EMBODIMENTS

Technologies for stopping power supply to in-vehicle devices when a breakdown occurs in a vehicle have been developed.

### DETAILED DESCRIPTION OF PREFERRED EMBODIMENTS

First, embodiments of the present disclosure will be listed and described.

In a first aspect, a vehicle service management device according to an embodiment of the present disclosure is a vehicle service management device installed in a vehicle, including: a monitoring unit configured to monitor a battery charge of a battery included in the vehicle in a target state in which the vehicle is stopped or parked; a suspension charge obtaining unit configured to obtain a suspension charge that is an amount of charge of the battery necessary to suspend a target service that is a service executed in the vehicle in the target state; and a determination unit configured to perform suspension determination processing for determining suspension of the target service that is being executed, based on the battery charge monitored by the monitoring unit and the suspension charge obtained by the suspension charge obtaining unit.

According to this configuration, when a service is being executed while the vehicle is stopped or parked, it is possible to perform determination regarding the suspension of the service based on a remaining charge of the battery and the amount of charge of the battery necessary to suspend the service, and therefore, the service that is being executed can be prevented from stopping at an unintended timing. Accordingly, the service that is being executed while the vehicle is stopped or parked can be suspended at an appropriate timing.

In a second aspect according to the first aspect, if the battery charge monitored by the monitoring unit is not larger than a value obtained by adding a predetermined margin value to the suspension charge obtained by the suspension charge obtaining unit, the determination unit may make a positive determination on the suspension in the suspension determination processing.

With this configuration, it is possible to determine to suspend the service that is being executed, for example, in a state where the remaining charge of the battery is sufficient, and therefore, it is possible to reduce the possibility of the suspension of the service failing midway.

In a third aspect according to the first or the second aspect, a plurality of in-vehicle devices may be installed in the vehicle, and the vehicle service management device may further include: an identification unit that, if a positive determination is made on the suspension by the determination unit in the suspension determination processing, identifies a service corresponding device that is an in-vehicle device corresponding to the target service that is being executed among the plurality of in-vehicle devices; and a stop processing unit that performs stop processing for stopping operations of the service corresponding device identified by the identification unit.

With this configuration, it is possible to stop the operations of the in-vehicle device corresponding to the service to be suspended, and accordingly, the service can be suspended more reliably.

In a fourth aspect according to the third aspect, the stop processing unit may be further configured to obtain order information indicating a correspondence relationship between the target service and an order in which operations of a plurality of the service corresponding devices are to be stopped, and based on the obtained order information, the stop processing unit may perform the stop processing in accordance with a corresponding order that is the order corresponding to the target service that is being executed.

According to this configuration, when the stop processing is performed on a plurality of service corresponding devices, it is possible to easily determine the order in which the operations of the plurality of service corresponding devices are to be stopped, by using the order information.

In a fifth aspect according to the fourth aspect, the vehicle service management device may further include: a power measurement unit configured to measure power consumption of each of the service corresponding devices; a stop time measurement unit configured to measure stop times that are necessary for the respective service corresponding devices to stop their operations; and an order information updating unit configured to update the corresponding order in the order information based on the power consumption measured by the power measurement unit and the stop times measured by the stop time measurement unit.

When the stop processing is performed on a plurality of service corresponding devices, this configuration makes it possible to stop the operations of the plurality of service corresponding devices in an appropriate order according to the actually measured values of the power consumption and the stop times of the service corresponding devices.

In a sixth aspect according to any of the first to the fifth aspects, the suspension charge obtaining unit may further obtain charge amount information indicating a correspondence relationship between the target service and the suspension charge, and the suspension charge obtaining unit may obtain the suspension charge corresponding to the target service that is being executed, based on the obtained charge amount information.

This configuration makes it possible to easily obtain the suspension charge used in the suspension determination processing, by using the charge amount information.

In a seventh aspect according to the sixth aspect, the vehicle service management device may further include a charge amount information updating unit configured to update, in the charge amount information, the suspension charge corresponding to the target service that was being executed when the monitoring unit monitored the battery charge, based on the battery charge monitored by the monitoring unit.

The amount of charge of the battery necessary to suspend the target service may change due to deterioration of the battery or the like, for example. In the above configuration, the suspension charge corresponding to the target service is updated in the charge amount information based on a monitoring result of the remaining charge of the battery monitored while the target service is being executed, and accordingly, it is possible to perform the suspension determination processing by using an appropriate suspension charge according to the state of the battery, and therefore, it is possible to perform the determination regarding the suspension of the target service more accurately.

In an eighth aspect, a vehicle service management method according to an embodiment of the present disclosure is a vehicle service management method performed by a vehicle service management device installed in a vehicle, the method including: a step of monitoring a battery charge of a battery included in the vehicle in a target state in which the vehicle is stopped or parked; a step of obtaining a suspension charge that is an amount of charge of the battery necessary to suspend a target service that is a service executed in the vehicle in the target state; and a step of performing suspension determination processing for determining suspension of the target service that is being executed, based on the monitored battery charge and the obtained suspension charge.

According to this configuration, when a service is being executed while the vehicle is stopped or parked, it is possible to perform determination regarding the suspension of the service based on a remaining charge of the battery and the amount of charge of the battery necessary to suspend the service, and therefore, the service that is being executed can be prevented from stopping at an unintended timing. Accordingly, the service that is being executed while the vehicle is stopped or parked can be suspended at an appropriate timing.

In a ninth aspect, a vehicle service management program according to an embodiment of the present disclosure is a vehicle service management program to be used by a vehicle service management device installed in a vehicle, the program causing a computer to function as: a monitoring unit configured to monitor a battery charge of a battery included in the vehicle in a target state in which the vehicle is stopped or parked; a suspension charge obtaining unit configured to obtain a suspension charge that is an amount of charge of the battery necessary to suspend a target service that is a service executed in the vehicle in the target state; and a determination unit configured to perform suspension determination processing for determining suspension of the target service that is being executed, based on the battery charge monitored by the monitoring unit and the suspension charge obtained by the suspension charge obtaining unit.

According to this configuration, when a service is being executed while the vehicle is stopped or parked, it is possible to perform determination regarding the suspension of the service based on a remaining charge of the battery and the amount of charge of the battery necessary to suspend the service, and therefore, the service that is being executed can be prevented from stopping at an unintended timing. Accordingly, the service that is being executed while the vehicle is stopped or parked can be suspended at an appropriate timing.

The following describes embodiments of the present disclosure with reference to the drawings. Note that elements that are identical with or correspond to each other are denoted with the same reference sign in the drawings, and redundant descriptions thereof are omitted. Also, at least parts of the following embodiments may be combined suitably.

### In-Vehicle System

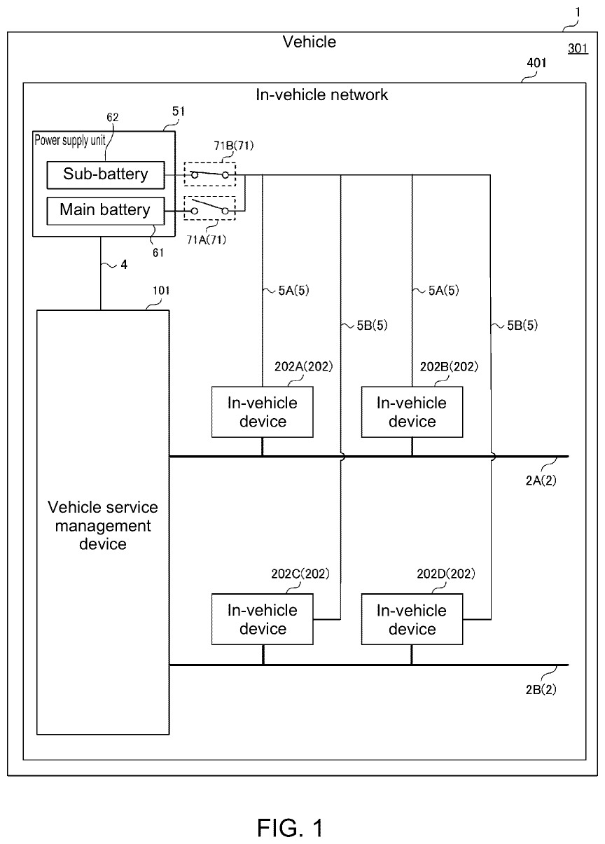

FIG. 1 is a diagram showing an example of a configuration of an in-vehicle system according to an embodiment of the present disclosure. As shown in FIG. 1, an in-vehicle system 301 includes a vehicle service management device 101, one or more in-vehicle devices 202, a power supply unit 51, and relays 71. FIG. 1 shows an example in which the in-vehicle system 301 includes a plurality of in-vehicle devices 202. The in-vehicle system 301 is installed in a vehicle 1.

The in-vehicle devices 202 are in-vehicle ECUs (Electronic Control Units), for example. Specifically, the in-vehicle devices 202 are a TCU (Telematics Communication Unit), an engine ECU, a body control ECU, an automatic driving ECU, a facial recognition ECU, a door lock ECU, etc. Note that the in-vehicle devices 202 are not limited to in-vehicle ECUs, and may also be an OTA (Over The Air) master, a sensor, a navigation device, a human machine interface, a camera, etc

The vehicle service management device 101 and the plurality of in-vehicle devices 202 constitute an in-vehicle network 401. The plurality of in-vehicle devices 202 are connected to the vehicle service management device 101 via CAN buses 2 that conform to CAN (Controller Area Network) standards, for example.

In-vehicle devices 202A and 202B, which are in-vehicle devices 202, are connected to the vehicle service management device 101 via a CAN bus 2A, which is a CAN bus 2. In-vehicle devices 202C and 202D, which are in-vehicle devices 202, are connected to the vehicle service management device 101 via a CAN bus 2B, which is a CAN bus 2.

For example, the vehicle service management device 101 and each in-vehicle device 202 transmit CAN frames including various types of information, such as information for assisting automatic driving of the vehicle 1 and information to be used for entertainment, and CAN-IDs (identifiers) indicating data types to other in-vehicle devices 202 or the vehicle service management device 101.

The vehicle service management device 101 and the in-vehicle devices 202 provide various services, i.e., applications in the vehicle 1 by communicating with each other.

Services executed in the vehicle 1 include, for example, a lighting control service for controlling timings at which headlights of the vehicle 1 are turned on, a surroundings monitoring service for monitoring the surroundings of the vehicle 1, and a software update service for updating various types of software used in the in-vehicle network 401 with use of OTA (Over The Air) technologies. The lighting control service is executed while the vehicle 1 is traveling, for example. The surroundings monitoring service and the software update service are executed in a target state in which the vehicle 1 is parked, for example.

### Wake-Up Mode and Sleep Mode

Each in-vehicle device 202 transitions from a wake-up mode to a sleep mode, and also transitions from the sleep mode to the wake-up mode. In the wake-up mode, each in-vehicle device 202 communicates with the other devices included in the in-vehicle system 301 and, in the sleep mode, each in-vehicle device 202 stops the communication with the other devices included in the in-vehicle system 301. Here, the sleep mode is a state in which the power consumption is smaller than in the wake-up mode due to some functions of the in-vehicle device 202 being stopped or a clock frequency of the in-vehicle device 202 being reduced, for example. For example, when the operation mode of an in-vehicle device 202 is the sleep mode, the in-vehicle device 202 can receive CAN frames.

For example, sleep conditions under which the in-vehicle devices 202 transition to the sleep mode and wake-up conditions under which the in-vehicle devices 202 transition to the wake-up mode are set in advance in the in-vehicle devices 202.

Examples of the sleep conditions include a condition that the vehicle 1 is parked, a condition that the vehicle 1 is stopped, and a condition that the ignition of the vehicle 1 is turned off. Examples of the wake-up conditions include a condition that the vehicle 1 starts to travel and a condition that the ignition of the vehicle 1 is turned on.

In the wake-up mode, the in-vehicle devices 202 transmit CAN frames (hereinafter also referred to as “NM frames”) in which NM (Network Management) messages in accordance with AUTOSAR (AUTomotive Open System ARchitecture) (registered trademark) are stored, to the devices included in the in-vehicle system 301. Specifically, in the wake-up mode, each in-vehicle device 202 broadcasts the NM frame to the devices for life-and-death monitoring.

On the other hand, the in-vehicle devices 202 stop the transmission of the NM frames when the operation modes of the in-vehicle devices 202 have transitioned from the wake-up mode to the sleep mode.

### Power Supply Unit

The power supply unit 51 supplies power in the vehicle 1. The power supply unit 51 is connected to the vehicle service management device 101 via a power supply line 4. The power supply unit 51 supplies power to the vehicle service management device 101 via the power supply line 4.

The power supply unit 51 is connected to the in-vehicle devices 202 via power supply lines 5. The power supply unit 51 supplies power to the in-vehicle devices 202 via the power supply lines 5.

More specifically, the power supply unit 51 is connected via power supply lines 5A, which are power supply lines 5, to the in-vehicle devices 202 that are connected to the CAN bus 2A. The in-vehicle devices 202 connected to the CAN bus 2A operate with power supplied from the power supply unit 51.

Also, the power supply unit 51 is connected via power supply lines 5B, which are power supply lines 5, to the in-vehicle devices 202 that are connected to the CAN bus 2B. The in-vehicle devices 202 connected to the CAN bus 2B operate with power supplied from the power supply unit 51.

The power supply unit 51 includes a main battery 61 and a sub-battery 62, for example. The power source for the devices included in the in-vehicle system 301 is switched to the main battery 61 or the sub-battery 62 according to the state of the vehicle 1, for example.

More specifically, the main battery 61 supplies power to the devices included in the in-vehicle system 301 while the vehicle 1 is traveling, for example. Also, the main battery 61 supplies power to the devices if the amount of charge of the sub-battery 62 (hereinafter also referred to as a “sub-battery charge”) is smaller than a predetermined threshold Th1 while the vehicle 1 is parked, for example. If the sub-battery charge is equal to or larger than the threshold Th1 while the vehicle 1 is parked, the sub-battery 62 supplies power to the devices.

Specifically, the relays 71 are devices for switching the power source for the devices in the in-vehicle system 301 to the main battery 61 or the sub-battery 62, for example. The in-vehicle system 301 includes relays 71A and 71B as the relays, for example.

The relay 71A is connected between the main battery 61 and the in-vehicle devices 202. The relay 71B is connected between the sub-battery 62 and the in-vehicle devices 202.

The relays 71A and 71B are switched on or off in accordance with control performed by a relay control device (not shown) included in the in-vehicle system 301.

For example, when an ignition power source of the vehicle 1 is turned on, the relay 71A is switched on and the relay 71B is switched off. For example, when the ignition power source is turned off and the sub-battery charge is smaller than the threshold Th1, the relay 71A is switched on and the relay 71B is switched off. For example, when the ignition power source is turned off and the sub-battery charge is larger than the threshold Th1, the relay 71A is switched off and the relay 71B is switched on.

Note that there is no limitation to the configuration in which the in-vehicle system 301 includes the two CAN buses 2, and a configuration is also possible in which the in-vehicle system 301 includes one CAN bus 2 or three or more CAN buses 2.

The vehicle service management device 101 and the in-vehicle devices 202 may also be configured to communicate with each other in accordance with a communication protocol such as CAN FD (CAN with Flexible Data Rate), Ethernet (registered trademark), FlexRay (registered trademark), MOST (Media Oriented System Transport) (registered trademark), LIN (Local Interconnect Network), or CXPI (Clock Extension Peripheral Interface) (registered trademark), instead of or in addition to communicating with each other in accordance with the CAN standards.

### Vehicle Service Management Device

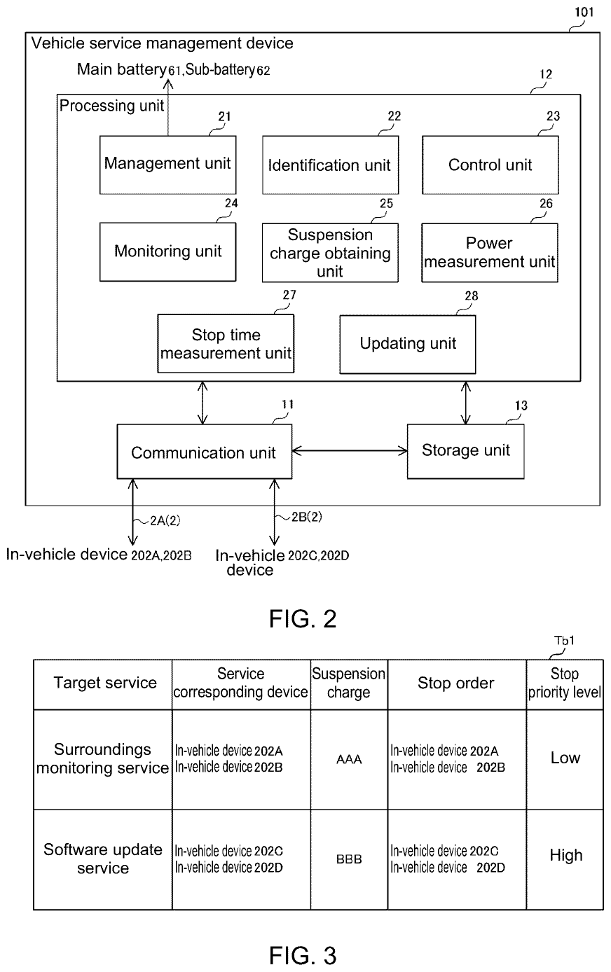

FIG. 2 is a diagram showing an example of a configuration of the vehicle service management device according to an embodiment of the present disclosure.

As shown in FIG. 2, the vehicle service management device 101 includes a communication unit 11, a processing unit 12, and a storage unit 13. The processing unit 12 includes a management unit 21, an identification unit 22, a control unit 23, a monitoring unit 24, a suspension charge obtaining unit 25, a power measurement unit 26, a stop time measurement unit 27, and an updating unit 28. One or both of the communication unit 11 and the processing unit 12 are realized by a processing circuitry including one or more processors. The storage unit 13 is a non-volatile memory included in the processing circuitry, for example. The management unit 21 is an example of a determination unit. The control unit 23 is an example of a stop processing unit.

### Execution of Target Service

The management unit 21 performs state determination processing for determining whether or not the vehicle 1 is in the target state. More specifically, the management unit 21 monitors an output voltage of the ignition power source of the vehicle 1 in the state determination processing, for example.

Specifically, for example, the management unit 21 measures the output voltage of the ignition power source of the vehicle 1, and if the measured voltage value is smaller than a predetermined threshold Th2, the management unit 21 determines that the vehicle 1 is parked, i.e., is in the target state. In this case, a sleep condition is satisfied, and accordingly, each in-vehicle device 202 transitions to the sleep mode.

On the other hand, if the voltage value is equal to or larger than the threshold Th2, the management unit 21 determines that the vehicle 1 is not in the target state.

The storage unit 13 stores, for example, category information indicating the category of a service (hereinafter also referred to as a “target service”) that is executed in the target state. In the present embodiment, the category information indicates, for example, the surroundings monitoring service and the software update service as the categories of target services.

Upon determining that the vehicle 1 is in the target state, the management unit 21 obtains the category information from the storage unit 13. Then, the management unit 21 outputs the obtained category information to the identification unit 22 and the suspension charge obtaining unit 25.

Upon receiving the category information from the management unit 21, the identification unit 22 identifies in-vehicle devices 202 (hereinafter also referred to as “service corresponding devices”) that correspond to the target services indicated by the category information.

More specifically, the storage unit 13 stores a correspondence table Tb1 that indicates a correspondence relationship E1 between the target services and the service corresponding devices, for example. The correspondence table Tb1 is registered in the storage unit 13 by the manufacturer of the vehicle 1 at the time of shipment of the vehicle 1, for example. The correspondence table Tb1 is an example of order information and is an example of charge amount information.

FIG. 3 is a diagram showing an example of the correspondence table stored in the vehicle service management device according to an embodiment of the present disclosure.

As shown in FIG. 3, according to the correspondence table Tb1, service corresponding devices (hereinafter also referred to as “service corresponding devices S1”) that correspond to the surroundings monitoring service are the in-vehicle devices 202A and 202B. Service corresponding devices (hereinafter also referred to as “service corresponding devices S2”) that correspond to the software update service are the in-vehicle devices 202C and 202D. “Suspension charge”, “stop order”, and “stop priority level” shown in FIG. 3 will be described later.

Upon receiving the category information from the management unit 21, the identification unit 22 identifies the service corresponding devices S1 and S2 by referring to the correspondence table Tb1 stored in the storage unit 13. Then, the identification unit 22 outputs device information D1 indicating the identified service corresponding devices S1 and S2 to the control unit 23.

Upon receiving the device information D1 from the identification unit 22, the control unit 23 performs control for causing the service corresponding devices S1 and S2 indicated by the device information D1 to transition to the wake-up mode.

Specifically, the storage unit 13 further stores a CAN table that indicates a correspondence relationship between the in-vehicle devices 202 and CAN-IDs, for example.

Upon receiving the device information D1 from the identification unit 22, the control unit 23 identifies CAN-IDs corresponding to the service corresponding devices S1 indicated by the device information D1 by referring to the CAN table stored in the storage unit 13. Specifically, the control unit 23 identifies a CAN-ID corresponding to the in-vehicle device 202A and a CAN-ID corresponding to the in-vehicle device 202B.

Also, the control unit 23 identifies CAN-IDs corresponding to the service corresponding devices S2 indicated by the device information D1. Specifically, the control unit 23 identifies a CAN-ID corresponding to the in-vehicle device 202C and a CAN-ID corresponding to the in-vehicle device 202D.

Upon identifying the CAN-IDs corresponding to the respective service corresponding devices, the control unit 23 creates a CAN frame (hereinafter may also be referred to as a “wake-up request frame”) including the identified CAN-IDs and a wake-up request, and outputs the CAN frame to the communication unit 11.

The storage unit 13 further stores a routing table indicating a correspondence relationship between CAN-IDs and CAN buses (hereinafter also referred to as “transmission destination buses”) to which destinations of CAN frames are connected.

Upon receiving the wake-up request frame from the control unit 23, the communication unit 11 identifies transmission destination buses corresponding to the CAN-IDs included in the wake-up request frame by referring to the routing table stored in the storage unit 13, and outputs the wake-up request frame to the identified transmission destination buses.

Upon receiving the wake-up request frame from the vehicle service management device 101, the service corresponding devices transition to the wake-up mode.

More specifically, upon receiving the wake-up request frame from the vehicle service management device 101, each service corresponding device confirms whether or not the CAN-ID of the service corresponding device is included in the wake-up request frame.

In the target state, service corresponding devices operating in the sleep mode dispose of CAN frames that do not include their CAN-IDs. On the other hand, upon receiving a wake-up request frame that includes their CAN-IDs, the service corresponding devices operating in the sleep mode boot power supply ICs (Integrated Circuitries, not shown) included in the service corresponding devices and transition to the wake-up mode. Then, the service corresponding devices communicate with other devices included in the in-vehicle system 301 with use of an output voltage of the power supply ICs.

### Description of Problem

The inventors of the present application found that maintaining the target services is likely to become difficult due to a reduction in at least either of the amount of charge of the main battery 61 and the amount of charge of the sub-battery 62 because the main battery 61 and the sub-battery 62 are not charged or are charged insufficiently while the vehicle 1 is stopped or parked. For example, if the power supply to the in-vehicle devices 202 corresponding to the target services stops at an unintended timing, a problem such as hang-up or breakdown may occur in the in-vehicle devices 202 and this may have an adverse influence on later provision of the services.

Therefore, the in-vehicle system 301 according to an embodiment of the present disclosure solves this problem with the following configuration and operations.

### Vehicle Service Management Device

### Monitoring Unit

Referring back to FIGS. 1 and 2, the monitoring unit 24 of the vehicle service management device 101 monitors the amount of charge of the main battery 61 (hereinafter also referred to as a “main battery charge”) and a sub-battery charge in the target state. The main battery charge and the sub-battery charge are the remaining amounts of charge of the respective batteries.

More specifically, the monitoring unit 24 measures an output current of the main battery 61 at predetermined intervals Ta, for example. Also, the monitoring unit 24 measures an elapsed time T2 from when the main battery 61 was fully charged. Then, the monitoring unit 24 calculates a used amount of charge of the main battery 61 by multiplying the measured current value of the main battery 61 by the elapsed time T2.

Also, the monitoring unit 24 measures an output current of the sub-battery 62 at the intervals Ta, for example. Also, the monitoring unit 24 measures an elapsed time T3 from when the sub-battery 62 was fully charged. Then, the monitoring unit 24 calculates a used amount of charge of the sub-battery 62 by multiplying the measured current value of the sub-battery 62 by the elapsed time T3.

The storage unit 13 stores the amount of charge of the fully charged main battery 61 and the amount of charge of the fully charged sub-battery 62, for example.

Upon calculating the used amount of charge of the main battery 61, the monitoring unit 24 calculates the main battery charge by subtracting the used amount of charge from the amount of charge of the fully charged main battery 61 stored in the storage unit 13.

Also, upon calculating the used amount of charge of the sub-battery 62, the monitoring unit 24 calculates the sub-battery charge by subtracting the used amount of charge from the amount of charge of the fully charged sub-battery 62 stored in the storage unit 13.

Then, the monitoring unit 24 outputs calculation result information indicating the calculated main battery charge and sub-battery charge to the management unit 21.

### Suspension Charge Obtaining Unit

The suspension charge obtaining unit 25 obtains amounts of charge (hereinafter also referred to as “suspension charges”) of the main battery 61 and the sub-battery 62 necessary to suspend the target services.

More specifically, for example, the correspondence table Tb1 stored in the storage unit 13 indicates a correspondence relationship E2 between the target services and the suspension charges, in addition to the correspondence relationship E1.

In the correspondence table Tb1 shown in FIG. 3, a suspension charge C1 corresponding to the surroundings monitoring service is “AAA” milliamperes. A suspension charge C2 corresponding to the software update service is “BBB” milliamperes.

Upon receiving the category information from the management unit 21, the suspension charge obtaining unit 25 obtains the correspondence table Tb1 from the storage unit 13. Then, the suspension charge obtaining unit 25 obtains the suspension charges corresponding to the target services that are being executed, based on the obtained correspondence table Tb1.

Specifically, upon receiving the category information from the management unit 21, for example, the suspension charge obtaining unit 25 reads the correspondence table Tb1 from the storage unit 13. Then, the suspension charge obtaining unit 25 identifies the suspension charge C1 and the suspension charge C2 respectively corresponding to the surroundings monitoring service and the software update service indicated by the category information by referring to the correspondence table Tb1. Then, the suspension charge obtaining unit 25 outputs suspension charge information indicating the identified suspension charges C1 and C2 to the management unit 21.

### Suspension Determination Processing

The management unit 21 performs suspension determination processing for determining suspension of the target services that are being executed, based on the main battery charge and the sub-battery charge monitored by the monitoring unit 24 and the suspension charges obtained by the suspension charge obtaining unit 25.

More specifically, upon receiving the suspension charge information from the suspension charge obtaining unit 25, the management unit 21 calculates, for example, a value (hereinafter referred to as a “reference value A”) by adding a predetermined margin value M to the sum of the suspension charge C1 and the suspension charge C2 indicated by the suspension charge information.

In the suspension determination processing, if both the main battery charge and the sub-battery charge monitored by the monitoring unit 24 are not larger than the reference value A, for example, the management unit 21 makes a positive determination on the suspension of the target services that are being executed.

Specifically, upon receiving the calculation result information from the monitoring unit 24, if both the main battery charge and the sub-battery charge indicated by the calculation result information are not larger than the reference value A, for example, the management unit 21 determines to suspend the surroundings monitoring service and the software update service, which are being executed.

Upon completing the suspension determination processing, the management unit 21 outputs suspension determination information indicating the categories of the target services that are determined to be suspended, i.e., the surroundings monitoring service and the software update service, to the identification unit 22.

On the other hand, if at least one of the main battery charge and the sub-battery charge obtained from the monitoring unit 24 is larger than the reference value A, the management unit 21 determines not to suspend the target services that are being executed.

### Identification of Service Corresponding Devices

Referring back to FIGS. 2 and 3, if a positive determination has been made on the suspension of the target services that are being executed in the suspension determination processing performed by the management unit 21, for example, the identification unit 22 identifies the service corresponding devices.

More specifically, upon receiving the suspension determination information from the management unit 21, the identification unit 22 identifies the plurality of service corresponding devices S1 corresponding to the surroundings monitoring service indicated by the suspension determination information by referring to the correspondence table Tb1 stored in the storage unit 13. Also, the identification unit 22 identifies the plurality of service corresponding devices S2 corresponding to the software update service indicated by the suspension determination information.

Then, the identification unit 22 outputs, to the control unit 23, device information D2 indicating the categories of the target services indicated by the suspension determination information received from the management unit 21 and the plurality of service corresponding devices corresponding to the target services.

### Stop Processing

For example, the control unit 23 performs stop processing for stopping operations of the plurality of service corresponding devices identified by the identification unit 22.

### Order Information

More specifically, for example, the correspondence table Tb1 stored in the storage unit 13 indicates a correspondence relationship E3 between the target services and orders in which operations of a plurality of service corresponding devices are to be stopped, in addition to the correspondence relationships E1 and E2.

In the correspondence table Tb1 shown in FIG. 3, the stop order corresponding to the surroundings monitoring service indicates that the in-vehicle device 202A is stopped first, and the in-vehicle device 202B is stopped second. The stop order corresponding to the software update service indicates that the in-vehicle device 202C is stopped first, and the in-vehicle device 202D is stopped second.

For example, if a plurality of service corresponding devices corresponding to a target service that is being executed are identified by the identification unit 22, the control unit 23 identifies an order (hereinafter may also be referred to as a “corresponding order”) corresponding to the target service that is being executed, based on the correspondence table Tb1 obtained from the storage unit 13.

Upon receiving the device information D2 from the identification unit 22, the control unit 23 reads the correspondence table Tb1 from the storage unit 13. Then, the control unit 23 identifies the corresponding orders respectively corresponding to the surroundings monitoring service and the software update service indicated by the device information D2 by referring to the correspondence table Tb1.

### Priority Level in Stop Processing

If the device information D2 received from the identification unit 22 indicates a plurality of target services, the control unit 23 performs the stop processing in the descending order of priority levels of the target services.

More specifically, for example, the correspondence table Tb1 stored in the storage unit 13 indicates a correspondence relationship E4 between the target services and priority levels in the stop processing (hereinafter also referred to as “stop priority levels”), in addition to the correspondence relationships E1 to E3.

In the correspondence table Tb1 shown in FIG. 3, the stop priority level of the surroundings monitoring service is low, and the stop priority level of the software update service is high.

Upon identifying the corresponding orders of the respective target services indicated by the device information D2 received from the identification unit 22, the control unit 23 checks the stop priority levels of the respective target services by referring to the correspondence table Tb1 stored in the storage unit 13.

### Sleep Request

Upon checking the stop priority levels of the respective target services, the control unit 23 performs the stop processing in accordance with the checked stop priority levels.

More specifically, upon checking the stop priority levels corresponding to the target services, for example, the control unit 23 performs the stop processing on a plurality of service corresponding devices corresponding to the target service having the highest stop priority level, in accordance with the identified corresponding order.

Specifically, in the stop processing, for example, the control unit 23 transmits a sleep request frame to the service corresponding devices corresponding to the target service having the highest stop priority level via the communication unit 11 and the transmission destination bus in accordance with the identified corresponding order.

In the present embodiment, the software update service is the target service having the highest stop priority level, and accordingly, the control unit 23 transmits the sleep request frame to the in-vehicle devices 202C and 202D corresponding to the software update service.

Upon transmitting the sleep request frame to the in-vehicle devices 202C and 202D, the control unit 23 performs the stop processing on a plurality of service corresponding devices corresponding to the target service having the second highest stop priority level, in accordance with the identified corresponding order. Here, the control unit 23 transmits the sleep request frame to the in-vehicle devices 202A and 202B corresponding to the surroundings monitoring service via the communication unit 11 and the transmission destination bus, in the same manner as in the stop processing performed on the in-vehicle devices 202C and 202D.

Upon transmitting the sleep request frame to the service corresponding devices, the control unit 23 outputs a transmission notification N1 indicating that the sleep request frame has been transmitted, to the monitoring unit 24 and the stop time measurement unit 27.

Upon receiving the sleep request frame from the vehicle service management device 101, the service corresponding devices transition to the sleep mode. Also, upon receiving the sleep request frame from the vehicle service management device 101, the service corresponding devices store various types of information obtained during the execution of the target services in storage units (not shown). Specifically, upon receiving the sleep request frame from the vehicle service management device 101, for example, a camera that is an example of the service corresponding devices executing the surroundings monitoring service stores information indicating a period of time for which the camera has operated during the execution of the surroundings monitoring service and captured images, etc., in the storage unit of the camera.

### Power Measurement Unit

Referring back to FIGS. 1 and 2, the power measurement unit 26 measures power consumption of each service corresponding device, for example.

More specifically, the power measurement unit 26 measures currents flowing through the power supply lines 5 connected to the respective service corresponding devices periodically in the target state, for example.

Also, the power measurement unit 26 measures voltages of the power supply lines 5 connected to the respective service corresponding devices periodically in the target state, for example. The power measurement unit 26 measures the voltages, for example, at the same timing as the timing at which the currents flowing through the power supply lines 5 are measured.

Then, the power measurement unit 26 calculates the power consumption of each service corresponding device at the time of measurement using the measured current value and voltage value, and stores power calculation information G11 indicating the calculation result in the storage unit 13.

Also, the power measurement unit 26 calculates a statistical value of the power consumption of each service corresponding device each time the predetermined period of time T11 has elapsed from the start of the target state, for example.

Specifically, the power measurement unit 26 calculates, for example, an average value of the power consumption of each service corresponding device using the power calculation information G11 accumulated in the storage unit 13 during the predetermined period of time T11. Then, the power measurement unit 26 outputs power statistical information G21 indicating the calculation result, i.e., the average value of the power consumption of each service corresponding device to the updating unit 28.

### Stop Time Measurement Unit

For example, the stop time measurement unit 27 measures stop times that are necessary for the respective service corresponding devices to stop their operations.

More specifically, upon receiving the transmission notification N1 from the control unit 23, the stop time measurement unit 27 starts a timer (not shown), for example.

If a new NM frame does not come from a service corresponding device even when a certain period of time has elapsed from when the sleep request frame was transmitted via the communication unit 11 to the plurality of service corresponding devices, the control unit 23 outputs a stop notification N2 indicating that the service corresponding device has stopped its operation, to the stop time measurement unit 27. The control unit 23 confirms that no new NM frame comes from the plurality of service corresponding devices, and outputs the stop notification N2 regarding each of the service corresponding devices to the stop time measurement unit 27.

Also, if a new NM frame no longer comes from any service corresponding device corresponding to a target service, the control unit 23 outputs an end notification N3 indicating that all service corresponding devices corresponding to the target service have stopped their operations, to the monitoring unit 24.

Upon receiving the stop notification N2 from the control unit 23, the stop time measurement unit 27 measures the period of time from when the timer was started to the reception of the stop notification N2, as the stop time of the service corresponding device indicated by the stop notification N2. Then, the stop time measurement unit 27 outputs stop time information K11 indicating the stop time of each service corresponding device to the updating unit 28.

### Statistical Table

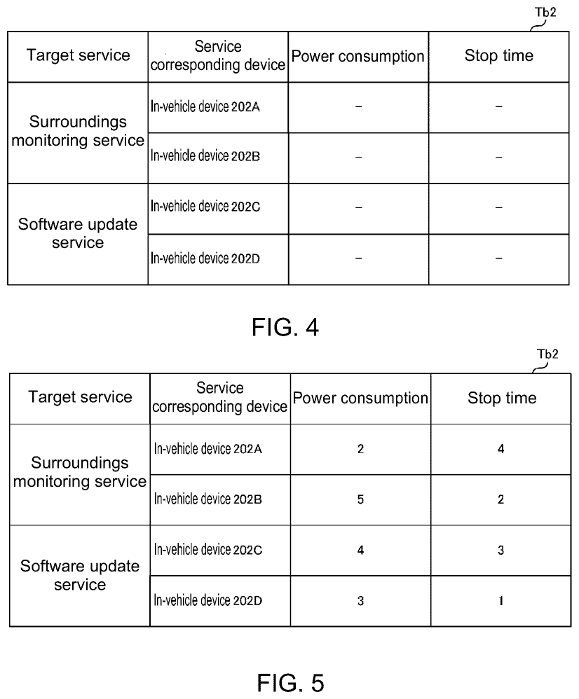

FIG. 4 is a diagram showing an example of a statistical table stored in the vehicle service management device according to an embodiment of the present disclosure.

As shown in FIGS. 2 and 4, the storage unit 13 further stores a statistical table Tb2 that indicates a correspondence relationship between the categories of target services, the service corresponding devices, relative values R1 of the power consumption, and relative values R2 of the stop time. The statistical table Tb2 is registered in the storage unit 13 by the manufacturer of the vehicle 1 at the time of shipment of the vehicle 1, for example.

FIG. 4 shows the statistical table Tb2 registered in the storage unit 13 at the time of shipment of the vehicle 1. Accordingly, in the statistical table Tb2 shown in FIG. 4, no values are registered as relative values R1 of the power consumption and relative values R2 of the stop time for the respective service corresponding devices that execute the surroundings monitoring service. Also, no values are registered as relative values R1 of the power consumption and relative values R2 of the stop time for the respective service corresponding devices that execute the software update service.

### Update of Statistical Table

Upon receiving the power statistical information G21 from the power measurement unit 26, the updating unit 28 determines whether or not to update the statistical table Tb2 stored in the storage unit 13.

More specifically, the storage unit 13 stores an estimated value of the power consumption in the target state with respect to each service corresponding device, for example.

Upon receiving the power statistical information G21 from the power measurement unit 26, the updating unit 28 stores the power statistical information G21 in the storage unit 13. Also, the updating unit 28 calculates, with respect to each service corresponding device, a relative value R1 of the power consumption by dividing the average value of the power consumption indicated by the power statistical information G21 by the estimated value of the power consumption stored in the storage unit 13.

For example, upon receiving the power statistical information G21 for the first time from the power measurement unit 26, the updating unit 28 determines to update the statistical table Tb2. Then, the updating unit 28 performs update processing L1 for registering the calculated relative value R1 in association with the service corresponding device in the statistical table Tb2.

Also, upon receiving the second or the following power statistical information G21 from the power measurement unit 26, the updating unit 28 confirms whether or not the currently calculated relative value R1 is the same as the relative value R1 of the power consumption of the corresponding service corresponding device shown in the statistical table Tb2 stored in the storage unit 13. If the currently calculated relative value R1 is the same as the relative value R1 of the power consumption of the corresponding service corresponding device shown in the statistical table Tb2, the updating unit 28 determines not to update the statistical table Tb2.

On the other hand, if the currently calculated relative value R1 is different from the relative value R1 of the power consumption of the corresponding service corresponding device shown in the statistical table Tb2, the updating unit 28 determines to update the statistical table Tb2. Then, the updating unit 28 performs the update processing L1 on the statistical table Tb2.

FIG. 5 is a diagram showing an example of the statistical table updated by the vehicle service management device according to an embodiment of the present disclosure.

As shown in FIG. 5, in the updated statistical table Tb2, the relative value R1 of the power consumption of the in-vehicle device 202A is “2”. The relative value R1 of the power consumption of the in-vehicle device 202B is “5”. The relative value R1 of the power consumption of the in-vehicle device 202C is “4”. The relative value R1 of the power consumption of the in-vehicle device 202D is “3”.

Also, upon receiving the stop time information K11 from the stop time measurement unit 27, the updating unit 28 determines whether or not to update the statistical table Tb2.

More specifically, the storage unit 13 stores an estimated value of the stop time with respect to each service corresponding device, for example.

Upon receiving the stop time information K11 from the stop time measurement unit 27, the updating unit 28 stores the stop time information K11 in the storage unit 13. Also, the updating unit 28 calculates, with respect to each service corresponding device, a relative value R2 of the stop time by dividing the stop time indicated by the stop time information K11 by the estimated value of the stop time stored in the storage unit 13.

For example, upon receiving the stop time information K11 for the first time from the stop time measurement unit 27, the updating unit 28 determines to update the statistical table Tb2. Then, the updating unit 28 performs update processing L2 for registering the calculated relative value R2 in association with the service corresponding device in the statistical table Tb2.

Also, upon receiving the second or the following stop time information K11 from the stop time measurement unit 27, for example, the updating unit 28 confirms whether or not the currently calculated relative value R2 is the same as the relative value R2 of the stop time of the corresponding service corresponding device shown in the statistical table Tb2 stored in the storage unit 13. If the currently calculated relative value R2 is the same as the relative value R2 of the stop time of the corresponding service corresponding device shown in the statistical table Tb2, the updating unit 28 determines not to update the statistical table Tb2.

On the other hand, if the currently calculated relative value R2 is different from the relative value R2 of the stop time of the corresponding service corresponding device shown in the statistical table Tb2, the updating unit 28 determines to update the statistical table Tb2. Then, the updating unit 28 performs the update processing L2 on the statistical table Tb2.

In the statistical table Tb2 shown in FIG. 5, the relative value R2 of the stop time of the in-vehicle device 202A is “4”. The relative value R2 of the stop time of the in-vehicle device 202B is “2”. The relative value R2 of the stop time of the in-vehicle device 202C is “3”. The relative value R2 of the stop time of the in-vehicle device 202D is “1”.

### Update of Correspondence Table

### Update of Stop Order

For example, the updating unit 28 updates a corresponding order in the correspondence table Tb1 based on the power consumption measured by the power measurement unit 26 and the stop time measured by the stop time measurement unit 27.

More specifically, when relative values R1 of the power consumption and relative values R2 of the stop time are newly registered in the statistical table Tb2, the updating unit 28 calculates, with respect to each service corresponding device, a value (hereinafter also referred to as a “multiplied value B”) by multiplying the relative value R1 by the relative value R2 corresponding to the service corresponding device.

Upon calculating the multiplied value B for each service corresponding device, the updating unit 28 determines a corresponding order based on the plurality of calculated multiplied values B.

Specifically, the updating unit 28 determines to sequentially stop the service corresponding devices in the ascending order of the multiplied values B, for example.

In the example shown in FIG. 5, as for the surroundings monitoring service, the multiplied value B corresponding to the in-vehicle device 202A is 8, and the multiplied value B corresponding to the in-vehicle device 202B is 10. In this case, the updating unit 28 determines the corresponding order of the surroundings monitoring service such that the in-vehicle device 202A will be stopped first and the in-vehicle device 202B will be stopped second.

Also, as for the software update service, the multiplied value B corresponding to the in-vehicle device 202C is 12, and the multiplied value B corresponding to the in-vehicle device 202D is 3. In this case, the updating unit 28 determines the corresponding order of the software update service such that the in-vehicle device 202D will be stopped first and the in-vehicle device 202C will be stopped second.

Upon determining the corresponding orders of the respective target services, the updating unit 28 reads the correspondence table Tb1 from the storage unit 13. Then, the updating unit 28 confirms, with respect to each target service, whether or not the determined corresponding order is the same as the corresponding order shown in the correspondence table Tb1 by referring to the correspondence table Tb1.

If the determined corresponding order is the same as the corresponding order shown in the correspondence table Tb1, the updating unit 28 determines not to update the correspondence relationship E3 in the correspondence table Tb1. On the other hand, if the determined corresponding order is different from the corresponding order shown in the correspondence table Tb1, the updating unit 28 updates the correspondence relationship E3 in the correspondence table Tb1.

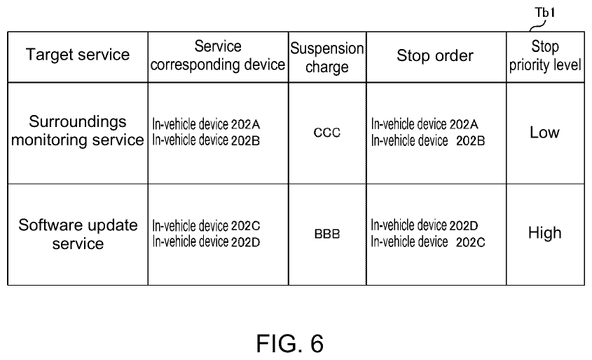

FIG. 6 is a diagram showing an example of the correspondence table updated by the vehicle service management device according to an embodiment of the present disclosure.

As shown in FIG. 6, in the updated correspondence table Tb1, the corresponding order corresponding to the software update service is changed from that shown in the correspondence table Tb1 shown in FIG. 3 such that the in-vehicle device 202D will be stopped first and the in-vehicle device 202C will be stopped second.

### Update of Suspension Charge

Also, for example, the updating unit 28 updates, in the correspondence table Tb1, the suspension charges corresponding to the target services that were being executed when the monitoring unit 24 monitored the main battery charge and the sub-battery charge, based on the main battery charge and the sub-battery charge monitored by the monitoring unit 24.

More specifically, upon receiving the transmission notification N1 from the control unit 23, for example, the monitoring unit 24 outputs calculation result information P1 indicating the latest main battery charge and the latest sub-battery charge to the updating unit 28.

Also, upon receiving the end notification N3 from the control unit 23, for example, the monitoring unit 24 outputs calculation result information P2 indicating the latest main battery charge and the latest sub-battery charge to the updating unit 28.

Upon receiving the calculation result information P1 and P2, the updating unit 28 calculates a suspension charge by subtracting the sum of the main battery charge and the sub-battery charge indicated by the calculation result information P2 from the sum of the main battery charge and the sub-battery charge indicated by the calculation result information P1.

Upon calculating the suspension charge of each target service, the updating unit 28 reads the correspondence table Tb1 from the storage unit 13. Then, the updating unit 28 confirms, with respect to each target service, whether or not the calculated suspension charge is the same as the suspension charge shown in the correspondence table Tb1 by referring to the correspondence table Tb1.

If the calculated suspension charge is the same as the suspension charge shown in the correspondence table Tb1, the updating unit 28 determines not to update the correspondence relationship E2 in the correspondence table Tb1. On the other hand, if the calculated suspension charge is different from the suspension charge shown in the correspondence table Tb1, the updating unit 28 determines to update the correspondence relationship E2 in the correspondence table Tb1.

In the updated correspondence table Tb1 shown in FIG. 6, the suspension charge corresponding to the surroundings monitoring service is changed to “CCC” milliamperes, when compared with the correspondence table Tb1 shown in FIG. 3.

### Flow of Operation

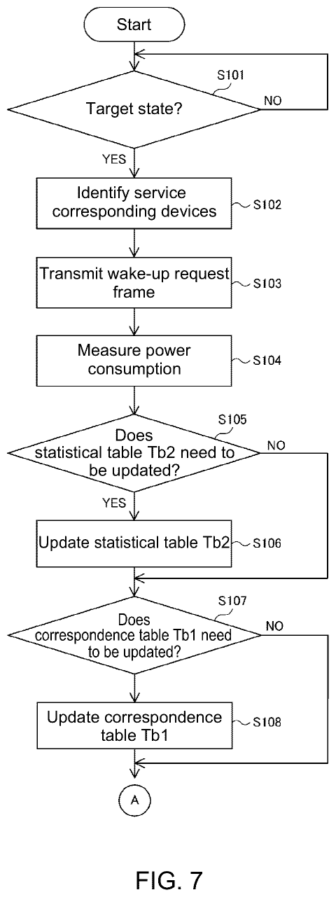

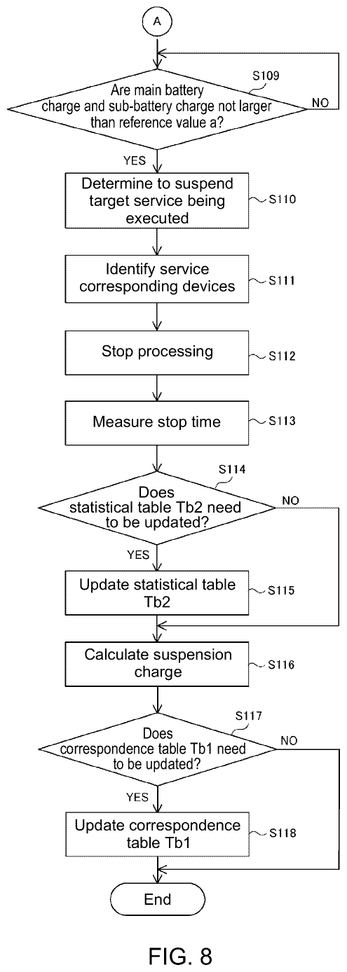

FIGS. 7 and 8 show a flowchart of an operation procedure of the suspension determination processing performed by the vehicle service management device according to an embodiment of the present disclosure.

As shown in FIG. 7, first, the vehicle service management device 101 determines whether or not the vehicle 1 is in the target state (step S101), and upon determining that the vehicle 1 is in the target state (YES in step S101), identifies service corresponding devices corresponding to one or more target services. In this case, it is assumed that the vehicle service management device 101 identifies a plurality of service corresponding devices (step S102).

Next, the vehicle service management device 101 transmits a wake-up request frame for causing the plurality of identified service corresponding devices to transition to the wake-up mode to the service corresponding devices (step S103).

Next, the vehicle service management device 101 measures the power consumption of each service corresponding device. For example, as described above, the vehicle service management device 101 periodically measures the power consumption of each service corresponding device, and stores power calculation information G11 indicating the measurement result in the storage unit 13 (step S104).

Next, the vehicle service management device 101 determines whether or not to update relative values R1 of the power consumption shown in the statistical table Tb2 stored in the storage unit 13. For example, the vehicle service management device 101 calculates a relative value R1 of the power consumption of each service corresponding device as described above. Then, the vehicle service management device 101 confirms whether or not the calculated relative value R1 is the same as the relative value R1 of the corresponding service corresponding device shown in the statistical table Tb2 (step S105).

Next, upon determining to update the statistical table Tb2 (YES in step S105), the vehicle service management device 101 performs the update processing L1 for registering the currently calculated relative value R1 in association with the service corresponding device in the statistical table Tb2 (step S106).

Next, the vehicle service management device 101 determines whether or not to update the correspondence relationship E3 between the categories of target services and stop orders shown in the correspondence table Tb1 stored in the storage unit 13. For example, the vehicle service management device 101 calculates, with respect to each service corresponding device, a multiplied value B by multiplying the relative value R1 of the power consumption by the relative value R2 of the stop time corresponding to the service corresponding device, and determines a stop order based on the plurality of calculated multiplied values B as described above. Then, the vehicle service management device 101 confirms whether or not the determined stop order is the same as the stop order shown in the correspondence table Tb1 (step S107).

Next, upon determining to update the correspondence table Tb1 (YES in step S107), the vehicle service management device 101 updates the correspondence relationship E3 in the correspondence table Tb1 (step S108).

Next, the vehicle service management device 101 confirms whether or not both the main battery charge and the sub-battery charge are not larger than the reference value A (step S109).

If both the main battery charge and the sub-battery charge are not larger than the reference value A (YES in step S109), the vehicle service management device 101 determines to suspend one or more target services that are being executed (step S110).

Next, the vehicle service management device 101 identifies one or more service corresponding devices corresponding to the one or more target services that are being executed. In this case, it is assumed that the vehicle service management device 101 identifies a plurality of service corresponding devices (step S111).

Next, the vehicle service management device 101 performs the stop processing for stopping the operations of the identified service corresponding devices. For example, the vehicle service management device 101 transmits a sleep request frame to the identified service corresponding devices (step S112) as described above.

Next, the vehicle service management device 101 measures stop times that are necessary for the respective service corresponding devices to stop their operations (step S113).

Next, the vehicle service management device 101 determines whether or not to update relative values R2 of the stop time shown in the statistical table Tb2 stored in the storage unit 13. For example, the vehicle service management device 101 calculates a relative value R2 of the stop time of each service corresponding device as described above. Then, the vehicle service management device 101 confirms whether or not the calculated relative value R2 is the same as the relative value R2 of the stop time of the corresponding service corresponding device shown in the statistical table Tb2 (step S114).

Next, upon determining to update any of the relative values R2 of the stop time shown in the statistical table Tb2 (YES in step S114), the vehicle service management device 101 performs the update processing L2 for registering the currently calculated relative value R2 in association with the service corresponding device in the statistical table Tb2 (step S115).

Next, the vehicle service management device 101 calculates suspension charges necessary to suspend the one or more target services that were being executed (step S116).

Next, the vehicle service management device 101 determines whether or not to update the correspondence table Tb1 stored in the storage unit 13. For example, the vehicle service management device 101 determines a stop order of the plurality of service corresponding devices based on the multiplied values B obtained by multiplying the relative values R1 of the power consumption by the relative values R2 of the stop time, which are shown in the statistical table Tb2, as described above. Then, the vehicle service management device 101 confirms whether or not the determined stop order is the same as the stop order shown in the correspondence table Tb1. Also, the vehicle service management device 101 confirms whether or not the calculated suspension charges are the same as the suspension charges shown in the correspondence table Tb1 (step S117).

Next, upon determining to update the correspondence table Tb1 (YES in step S117), the vehicle service management device 101 updates at least one of the correspondence relationship E3 between the categories of the target services and stop orders and the correspondence relationship E2 between the categories of the target services and the suspension charges in the correspondence table Tb1 (step S118).

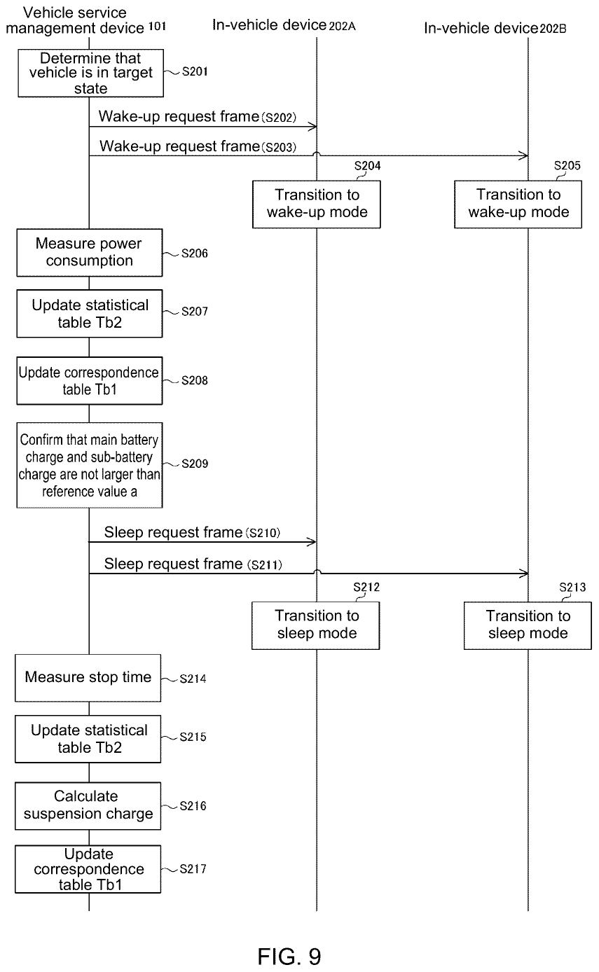

FIG. 9 is a diagram showing an example of a sequence of processing performed by the vehicle service management device and in-vehicle devices included in the in-vehicle system according to an embodiment of the present disclosure.

As shown in FIG. 9, first, the vehicle service management device 101 determines that the vehicle 1 is in the target state (step S201).

Next, the vehicle service management device 101 identifies service corresponding devices corresponding to one or more target services that are executed in the target state, and transmits a wake-up request frame to the identified service corresponding devices. Here, the vehicle service management device 101 identifies the in-vehicle devices 202A and 202B as the service corresponding devices, and transmits a wake-up request frame to the in-vehicle devices 202A and 202B (steps S202 and S203).

Next, the in-vehicle devices 202A and 202B transition to the wake-up mode (steps S204 and S205).

Next, the vehicle service management device 101 measures the power consumption of each of the in-vehicle devices 202A and 202B (step S206).

Next, the vehicle service management device 101 determines whether or not to update relative values R1 of the power consumption shown in the statistical table Tb2. For example, the vehicle service management device 101 calculates a relative value R1 of the power consumption of each service corresponding device as described above. Then, the vehicle service management device 101 confirms whether or not the calculated relative value R1 is the same as the relative value R1 of the power consumption of the corresponding service corresponding device shown in the statistical table Tb2. Here, it is assumed that the vehicle service management device 101 determines to update any of the relative values R1 shown in the statistical table Tb2 (step S207).

Next, the vehicle service management device 101 determines whether or not to update the correspondence relationship E3 between the categories of target services and stop orders shown in the correspondence table Tb1. Here, it is assumed that the vehicle service management device 101 determines to update the correspondence relationship E3 (step S208).

Next, the vehicle service management device 101 confirms whether or not both the main battery charge and the sub-battery charge are not larger than the reference value A. Here, it is assumed that the vehicle service management device 101 confirms that both the main battery charge and the sub-battery charge are not larger than the reference value A (step S209).

Next, the vehicle service management device 101 identifies the in-vehicle devices 202A and 202B as the service corresponding devices corresponding to the target service that is being executed, and transmits a sleep request frame to the in-vehicle devices 202A and 202B (steps S 210 and S 211).

Next, the in-vehicle devices 202A and 202B transition to the sleep mode (steps S212 and S213).

Next, the vehicle service management device 101 measures the stop time of each of the in-vehicle devices 202A and 202B (step S214).

Next, the vehicle service management device 101 determines whether or not to update relative values R2 of the stop time shown in the statistical table Tb2 stored in the storage unit 13. For example, the vehicle service management device 101 calculates a relative value R2 of the stop time of each service corresponding device as described above. Then, the vehicle service management device 101 confirms whether or not the calculated relative value R2 is the same as the relative value R2 of the stop time of the corresponding service corresponding device shown in the statistical table Tb2. Here, it is assumed that the vehicle service management device 101 determines to update any of the relative values R2 shown in the statistical table Tb2 (step S215).

Next, the vehicle service management device 101 calculates a suspension charge necessary to suspend the target service that was being executed (step S216).

Next, the vehicle service management device 101 determines whether or not to update the correspondence table Tb1 stored in the storage unit 13. For example, the vehicle service management device 101 determines a stop order of the plurality of service corresponding devices based on multiplied values B obtained by multiplying the relative values R1 of the power consumption and the relative values R2 of the stop time shown in the statistical table Tb2, as described above. Then, the vehicle service management device 101 confirms whether or not the determined stop order is the same as the stop order shown in the correspondence table Tb1. Also, the vehicle service management device 101 confirms whether or not the calculated suspension charge is the same as the suspension charge shown in the correspondence table Tb1. Here, it is assumed that the vehicle service management device 101 determines to update the correspondence relationship E3 in the correspondence table Tb1 (step S217).

In the in-vehicle system 301 according to the embodiment of the present disclosure, the vehicle service management device 101 determines, in the suspension determination processing, whether or not it is necessary to suspend the target services that are being executed, but there is no limitation to this configuration. The vehicle service management device 101 may also be configured to determine a probability of the sum of the main battery charge and the sub-battery charge becoming equal to or smaller than the suspension charges of the target services that are being executed in the target state. In this case, in the suspension determination processing, the vehicle service management device 101 calculates, with respect to each target service, the probability according to a difference between the sum of the main battery charge and the sub-battery charge in the target state and the suspension charge shown in the correspondence table Tb1, and if the calculated probability is equal to or higher than a predetermined threshold, the vehicle service management device performs the stop processing.

In the in-vehicle system 301 according to the embodiment of the present disclosure, the vehicle service management device 101 identifies service corresponding devices upon making a positive determination on the suspension of a target service, and performs the stop processing on the service corresponding devices, but there is no limitation to this configuration. For example, the vehicle service management device 101 may also be configured to notify the user of the vehicle 1 of the determination result upon making a positive determination on the suspension of a target service.

In the in-vehicle system 301 according to the embodiment of the present disclosure, when performing the stop processing on a plurality of service corresponding devices, the vehicle service management device 101 identifies a stop order corresponding to the target service that is being executed, and performs the stop processing in accordance with the identified stop order, but there is no limitation to this configuration. The vehicle service management device 101 may also be configured to stop the operations of the plurality of service corresponding devices at the same time.

In the in-vehicle system 301 according to the embodiment of the present disclosure, the vehicle service management device 101 updates the correspondence relationship E3 between the categories of target services and stop orders in the correspondence table Tb1 based on the power consumption and stop time of each service corresponding device, but there is no limitation to this configuration. The vehicle service management device 101 may also be configured so as not to update the correspondence relationship E3 in the correspondence table Tb1.

In the in-vehicle system 301 according to the embodiment of the present disclosure, the vehicle service management device 101 calculates the relative value R1 of the power consumption and the relative value R2 of the stop time of each service corresponding device, but there is no limitation to this configuration. A configuration is also possible in which a device other than the vehicle service management device 101, for example, a server outside the vehicle calculates the relative values R1 and R2.

In the in-vehicle system 301 according to the embodiment of the present disclosure, the vehicle service management device 101 obtains, in the suspension determination processing, a suspension charge using the correspondence table Tb1 indicating the correspondence relationship E2 between the categories of target services and suspension charges, but there is no limitation to this configuration. The vehicle service management device 101 may also be configured to calculate the suspension charge using, for example, a predetermined arithmetic expression in the suspension determination processing.

In the in-vehicle system 301 according to the embodiment of the present disclosure, the vehicle service management device 101 updates the correspondence relationship E2 between the categories of target services and suspension charges in the correspondence table Tb1 based on a main battery charge and a sub-battery charge monitored while the target services are being executed, but there is no limitation to this configuration. The vehicle service management device 101 may also be configured so as not to update the correspondence relationship E2 in the correspondence table Tb1.

In the in-vehicle system 301 according to the embodiment of the present disclosure, the power supply unit 51 is configured to include two batteries, that is, the main battery 61 and the sub-battery 62, but there is no limitation to this configuration. The power supply unit 51 may also be configured to include one battery or three or more batteries.

### Variation 1

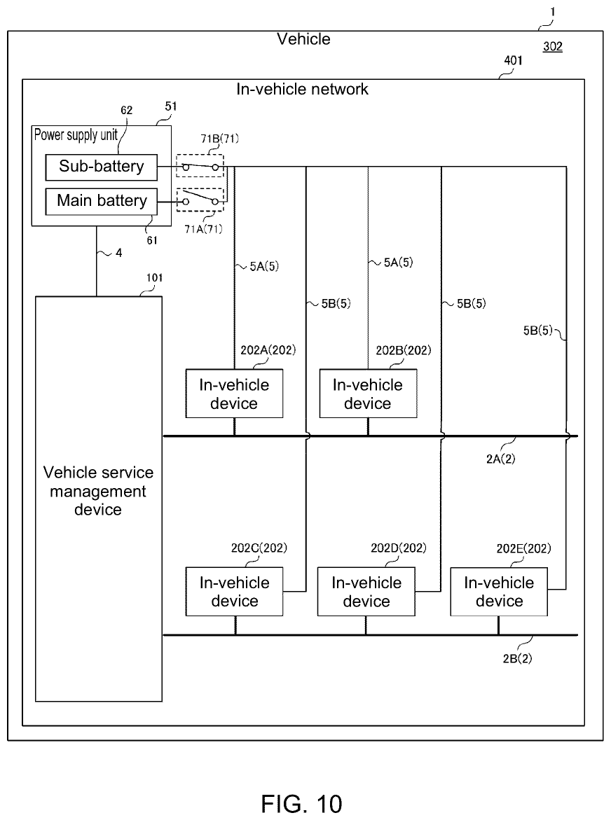

FIG. 10 is a diagram showing an example of a configuration of an in-vehicle system according to Variation 1 of the embodiment of the present disclosure. As shown in FIG. 10, an in-vehicle system 302 further includes an in-vehicle device 202E as an in-vehicle device 202, compared with the in-vehicle system 301 shown in FIG. 1. The in-vehicle device 202E is connected to the vehicle service management device 101 via the CAN bus 2B. Also, the in-vehicle device 202E is connected to the power supply unit 51 via a power supply line 5B.

Hereinafter, the in-vehicle device 202 newly added to the in-vehicle network 401 is also referred to as a “new device”, and the in-vehicle network 401 including the new device is also referred to as a “new network”.

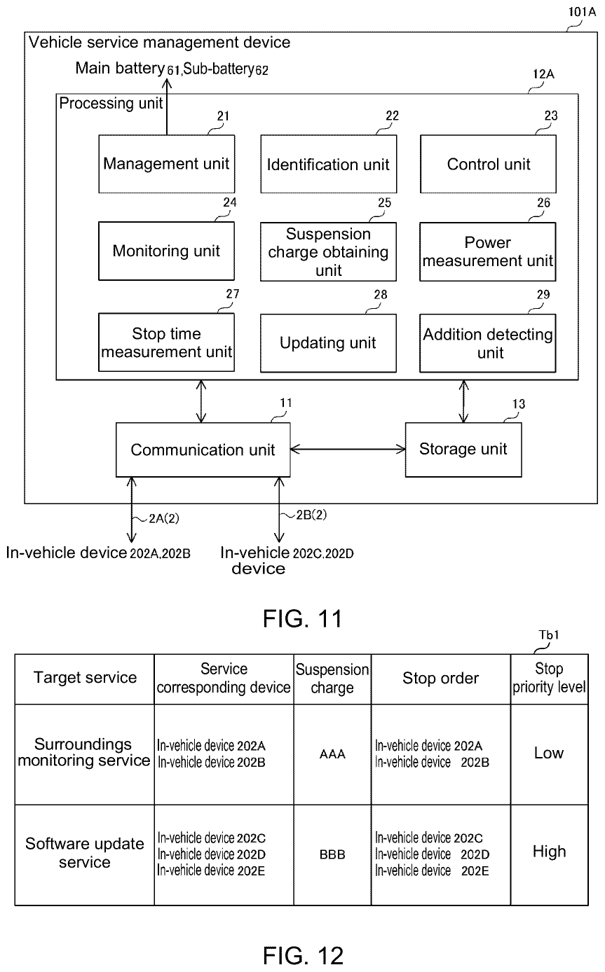

FIG. 11 is a diagram showing an example of a configuration of the vehicle service management device according to Variation 1 of the embodiment of the present disclosure. As shown in FIG. 11, a vehicle service management device 101A includes a communication unit 11, a processing unit 12A, and a storage unit 13. One or both of the communication unit 11 and the processing unit 12A are realized by a processing circuitry including one or more processors. The storage unit 13 is a non-volatile memory included in the processing circuitry, for example.

### Addition Detecting Unit

Compared with the processing unit 12 shown in FIG. 2, the processing unit 12A further includes an addition detecting unit 29. The addition detecting unit 29 detects addition of an in-vehicle device 202 to the in-vehicle network 401. In Variation 1, the addition detecting unit 29 detects addition of the in-vehicle device 202E to the in-vehicle network 401.

More specifically, when the in-vehicle device 202E is connected to the CAN bus 2B, the in-vehicle device 202E transmits a CAN frame (hereinafter also referred to as a “connection request frame”) for requesting connection for communication in the in-vehicle network 401 to the vehicle service management device 101.

Upon receiving the connection request frame from the in-vehicle device 202E via the communication unit 11, the addition detecting unit 29 of the vehicle service management device 101 performs processing for authenticating the in-vehicle device 202E with use of an authentication ID and an authentication password, which are included in the connection request frame.

Upon successfully authenticating the in-vehicle device 202E, the addition detecting unit 29 transmits a notification indicating the success of the authentication and category request information requesting a notification of the category of a service corresponding to the in-vehicle device 202E, via the communication unit 11 and the CAN bus 2B to the in-vehicle device 202E.

Upon receiving the category request information from the vehicle service management device 101, the in-vehicle device 202E transmits, to the vehicle service management device 101, service information indicating the category of a service corresponding to the in-vehicle device 202E, in response to the received category request information. In Variation 1, the in-vehicle device 202E transmits, for example, service information indicating the software update service as the category of the service corresponding to the in-vehicle device 202E, to the vehicle service management device 101.

Upon receiving the service information from the in-vehicle device 202E via the communication unit 11, the addition detecting unit 29 of the vehicle service management device 101 confirms whether or not the category of the service indicated by the received service information is a target service by referring to the category information in the storage unit 13.

Then, if the service indicated by the service information is a target service, the addition detecting unit 29 outputs device addition information that indicates the in-vehicle device 202E added to the in-vehicle network 401 and the category of the target service to the updating unit 28.

Note that the addition detecting unit 29 may be configured to broadcast a search message for detecting additional functional units via the communication unit 11 periodically, for example. In this case, the additional functional units receive the search message and transmit the connection request information as a response to the received search message.

### Update of Correspondence Table

Upon receiving the device addition information from the addition detecting unit 29, the updating unit 28 updates the correspondence relationship E1 between target services and service corresponding devices in the correspondence table Tb1 shown in FIG. 3.

More specifically, upon receiving the device addition information from the addition detecting unit 29, for example, the updating unit 28 reads the correspondence table Tb1 and the statistical table Tb2 from the storage unit 13. Then, the updating unit 28 newly registers the in-vehicle device 202E indicated by the device addition information in the correspondence table Tb1 and the statistical table Tb2, as a service corresponding device corresponding to a target service of the same category as the service indicated by the device addition information, that is, the software update service.

Also, the updating unit 28 updates, in the statistical table Tb2, the stop order corresponding to the software update service by adding the in-vehicle device 202E indicated by the device addition information received from the addition detecting unit 29 to the last.

FIG. 12 is a diagram showing an example of the correspondence table updated by the vehicle service management device according to Variation 1 of the embodiment of the present disclosure.

As shown in FIG. 12, in the updated correspondence table Tb1, the “in-vehicle device 202E” is newly registered as a service corresponding device corresponding to the “software update service”, compared with the correspondence table Tb1 shown in FIG. 3. Also, the stop order corresponding to the “software update service” is changed such that the in-vehicle device 202A will be stopped first, the in-vehicle device 202B will be stopped second, and the in-vehicle device 202E will be stopped third.

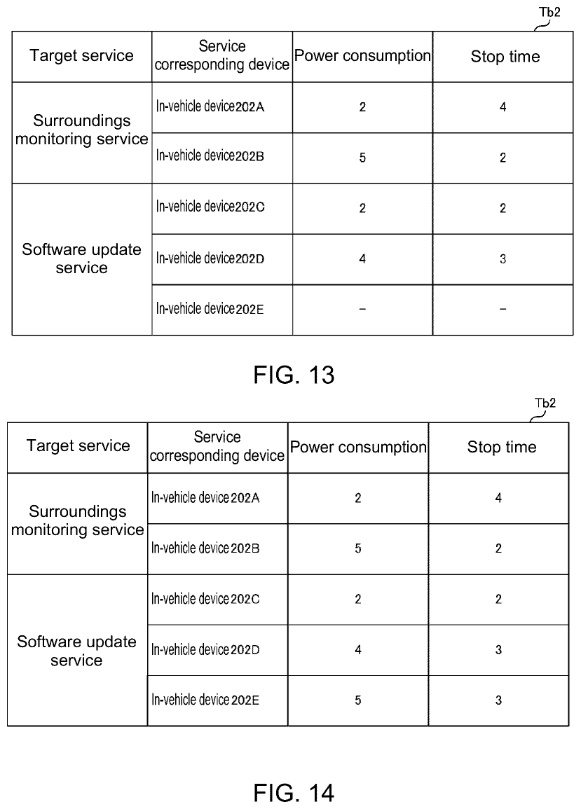

FIG. 13 is a diagram showing an example of a statistical table updated by the vehicle service management device according to Variation 1 of the embodiment of the present disclosure.

As shown in FIG. 13, in the updated statistical table Tb2, the “in-vehicle device 202E” is newly registered as a service corresponding device corresponding to the “software update service”, compared with the statistical table Tb2 shown in FIG. 5. No values are registered as the relative value of the power consumption and the relative value of the stop time of the in-vehicle device 202E.

Referring back to FIG. 11, the power measurement unit 26 calculates the power consumption of each service corresponding device in the new network periodically in the target state, for example, and stores power calculation information G12 indicating the calculation result in the storage unit 13.

Also, the power measurement unit 26 calculates, for example, an average value of the power consumption of each service corresponding device in the new network using the power calculation information G12 accumulated in the storage unit 13 during a predetermined period of time T11. Then, the power measurement unit 26 outputs power statistical information G22 indicating the calculation result to the updating unit 28.

The stop time measurement unit 27 measures the stop time of each service corresponding device in the new network, and outputs stop time information K21 indicating the measurement result to the updating unit 28.

### Update of Statistical Table

Upon receiving the power statistical information G22 from the power measurement unit 26, the updating unit 28 determines whether or not to update relative values R1 of the power consumption shown in the statistical table Tb2. Then, upon determining to update any of the relative values R1 shown in the statistical table Tb2, the updating unit 28 performs the update processing L1 described above.

Also, upon receiving the stop time information K21 from the stop time measurement unit 27, the updating unit 28 determines whether or not to update relative values R2 of the stop time shown in the statistical table Tb2. Then, upon determining to update any of the relative values R2 shown in the statistical table Tb2, the updating unit 28 performs the update processing L2 described above.

FIG. 14 is a diagram showing another example of the statistical table updated by the vehicle service management device according to an embodiment of the present disclosure.

As shown in FIG. 14, in the updated statistical table Tb2, “5” is newly registered as the relative value R1 of the power consumption of the in-vehicle device 202E and “3” is newly registered as the relative value R2 of the stop time of the in-vehicle device 202E, compared with the statistical table Tb2 shown in FIG. 13.

### Variation 2

The management unit 21 of the vehicle service management device 101 may also be configured to determine, in the suspension determination processing, to suspend target services that are being executed, in response to a predetermined operation made by the user of the vehicle 1.

More specifically, for example, the user performs an operation to instruct the start of a desired service on a navigation device (not shown) provided in the vehicle 1.

Specifically, for example, the user performs an operation on the navigation device to instruct the start of a service (hereinafter also referred to as a “power saving service”) for improving a power saving function of the vehicle 1. Upon receiving the operation from the user, the navigation device transmits, to the vehicle service management device 101, service start information indicating that the power saving service should be started, based on the content of the received operation.

Upon receiving the service start information from the navigation device via the communication unit 11, the management unit 21 of the vehicle service management device 101 performs the suspension determination processing.

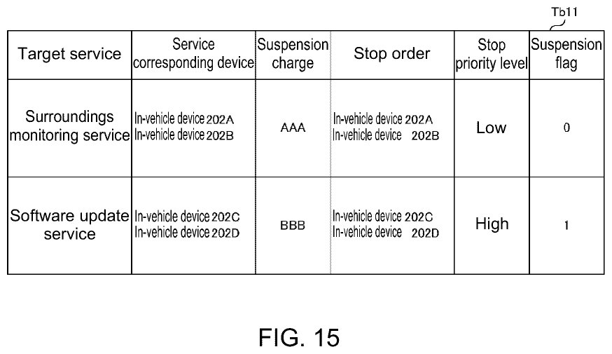

FIG. 15 is a diagram showing an example of a correspondence table stored in the vehicle service management device according to Variation 2 of the embodiment of the present disclosure.

As shown in FIG. 15, a correspondence table Tb11 includes suspension flags in addition to the correspondence relationships E1 to E4, compared with the correspondence table Tb1 shown in FIG. 3. The suspension flags indicate whether or not the target services that are being executed are to be suspended.

In the correspondence table Tb11, a suspension flag “1” indicates a target service that is suspended when the power saving service is executed. A suspension flag “0” indicates a target service that is not suspended when the power saving service is executed.

In the correspondence table Tb11, the suspension flag of the surroundings monitoring service is “0”. The suspension flag of the software update service is “1”.

Upon receiving the service start information from the navigation device, the management unit 21 reads the correspondence table Tb11 from the storage unit 13. Then, the management unit 21 determines to suspend the software update service of which the suspension flag is “1” by referring to the correspondence table Tb11.

The above embodiment is illustrative in all aspects, and should not be construed as limiting. The scope of the present disclosure is indicated by the claims rather than by the above description, and all changes which come within the meaning and range of equivalence of the claims are intended to be embraced therein.

Each processing (each function) of the above embodiment is realized by a processing circuitry including one or more processors. The processing circuitry may be constituted by, for example, an integrated circuit in which one or more memories, various analog circuits, and various digital circuits are combined in addition to the one or more processors. The one or more memories store a program (commands) for causing the one or more processors to execute each processing. The one or more processors may execute the above processing in accordance with the program read from the one or more memories, or may execute the above processing in accordance with a logic circuit designed to execute the above processing in advance. The above processors may be various processors adapted for the control of a computer, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that the plurality of physically separated processors may cooperate to execute each processing described above. For example, the processors installed in a plurality of physically separated computers may cooperatively execute each processing described above via a network such as a LAN (Local Area Network), a WAN (Wide Area Network), and the Internet. The above program may be installed in the memories from an external server device or the like via the network, or may be distributed in a state stored in a recording medium such as a CD-ROM (Compact Disc Read Only Memory), a DVD-ROM (Digital Versatile Disk Read Only Memory), or a semiconductor memory and installed from the recording medium into the memories.

The above description includes the following features.

### Appendix 1

A vehicle service management device installed in a vehicle, the vehicle service management device including: a processing circuitry configured to: monitor a battery charge of a battery included in the vehicle in a target state in which the vehicle is stopped or parked; obtain a suspension charge that is an amount of charge of the battery necessary to suspend a target service that is a service executed in the vehicle in the target state; and perform suspension determination processing for determining suspension of the target service that is being executed, based on the monitored battery charge and the obtained suspension charge.

1. A vehicle service management device installed in a vehicle, the vehicle service management device comprising:
a monitoring unit configured to monitor a battery charge of a battery included in the vehicle in a target state in which the vehicle is stopped or parked;
a suspension charge obtaining unit configured to obtain a suspension charge that is an amount of charge of the battery necessary to suspend a target service that is a service executed in the vehicle in the target state; and
a determination unit configured to perform suspension determination processing for determining suspension of the target service that is being executed, based on the battery charge monitored by the monitoring unit and the suspension charge obtained by the suspension charge obtaining unit.

2. The vehicle service management device according to claim 1,
wherein, if the battery charge monitored by the monitoring unit is not larger than a value obtained by adding a predetermined margin value to the suspension charge obtained by the suspension charge obtaining unit, the determination unit makes a positive determination on the suspension in the suspension determination processing.

3. The vehicle service management device according to claim 1,
wherein a plurality of in-vehicle devices are installed in the vehicle, and
the vehicle service management device further comprises:
an identification unit that, if a positive determination is made on the suspension by the determination unit in the suspension determination processing, identifies a service corresponding device that is an in-vehicle device corresponding to the target service that is being executed among the plurality of in-vehicle devices; and
a stop processing unit that performs stop processing for stopping operations of the service corresponding device identified by the identification unit.

4. The vehicle service management device according to claim 3,
wherein the stop processing unit is further configured to obtain order information indicating a correspondence relationship between the target service and an order in which operations of a plurality of the service corresponding devices are to be stopped, and
based on the obtained order information, the stop processing unit performs the stop processing in accordance with a corresponding order that is the order corresponding to the target service that is being executed.

5. The vehicle service management device according to claim 4, further including;
a power measurement unit configured to measure power consumption of each of the service corresponding devices;
a stop time measurement unit configured to measure stop times that are necessary for the respective service corresponding devices to stop their operations; and
an order information updating unit configured to update the corresponding order in the order information based on the power consumption measured by the power measurement unit and the stop times measured by the stop time measurement unit.

6. The vehicle service management device according to claim 1,
wherein the suspension charge obtaining unit further obtains charge amount information indicating a correspondence relationship between the target service and the suspension charge, and
the suspension charge obtaining unit obtains the suspension charge corresponding to the target service that is being executed, based on the obtained charge amount information.

7. The vehicle service management device according to claim 6, further including;
a charge amount information updating unit configured to update, in the charge amount information, the suspension charge corresponding to the target service that was being executed when the monitoring unit monitored the battery charge, based on the battery charge monitored by the monitoring unit.

8. A vehicle service management method performed by a vehicle service management device installed in a vehicle, the vehicle service management method comprising:
a step of monitoring a battery charge of a battery included in the vehicle in a target state in which the vehicle is stopped or parked;
a step of obtaining a suspension charge that is an amount of charge of the battery necessary to suspend a target service that is a service executed in the vehicle in the target state; and
a step of performing suspension determination processing for determining suspension of the target service that is being executed, based on the monitored battery charge and the obtained suspension charge.

9. A vehicle service management program to be used by a vehicle service management device installed in a vehicle, the vehicle service management program causing a computer to function as:
a monitoring unit configured to monitor a battery charge of a battery included in the vehicle in a target state in which the vehicle is stopped or parked;
a suspension charge obtaining unit configured to obtain a suspension charge that is an amount of charge of the battery necessary to suspend a target service that is a service executed in the vehicle in the target state; and
a determination unit configured to perform suspension determination processing for determining suspension of the target service that is being executed, based on the battery charge monitored by the monitoring unit and the suspension charge obtained by the suspension charge obtaining unit.
